(19) United States
(12) Patent Application Publication
(10) Pub. No.: US 2005/0184495 A1
(43) Pub. Date: Aug. 25, 2005

(54) Safety system for use in a vehicle

(76) Inventor: Bernd Zerbe, Nackenheim (DE)

Correspondence Address: CARY W. BROOKS;General Motors Corporation, Mail Code 482-C23-B21, P.O. Box 300, Detroit, MI, 48265-3000, US

(21) Appl. No.: 11/004,039

(22) Filed: Dec. 3, 2004

(30) Foreign Application Priority Data
Dec. 30, 2003 (DE) 103 61647.0

(51) Int. Cl. B60R 21/00

(52) U.S. Cl. 280/735; 180/282

(57) ABSTRACT

A safety system for use in a vehicle having a fuel cell system with a fuel supply means and an electrical energy source, wherein a plurality of sensors are associated with the fuel cell system and deliver safety relevant signals, these sensors are connected to a safety control and the fuel cell system has at least one device for switching off the fuel supply device and also at least one device which can be actuated by the safety control for separating at least one component of the fuel cell system from the electrical energy source, is characterized in that the safety system stands in association with an airbag system having at least one airbag with at least one gas generator associated with the airbag for the inflation of the airbag, preferably also with at least one safety belt with a belt tensioner, with an airbag control controlling the gas generator and optionally also the belt tensioner and also a plurality of sensors which are connected via a circuit to the airbag control and deliver safety relevant signals for the triggering of the airbag and/or of the belt tensioner; and in that the safety control of the fuel cell system is either connected to the airbag control or the airbag control functionally replaces the safety control of the fuel cell system.

### CROSS REFERENCE TO RELATED APPLICATION

This application claims priority to German Application No. 103 61 647.0 filed Dec. 30, 2003.

### FIELD OF THE INVENTION

This invention relates to a safety system for use in a vehicle.

### BACKGROUND OF THE INVENTION

The present invention relates to a safety system for use in a vehicle having a fuel cell system with a fuel supply means and an electrical energy source, wherein a plurality of sensors are associated with the fuel cell system and deliver safety relevant signals, these sensors are connected to a safety control and the fuel cell system has at least one device for switching off the fuel supply means and also at least one device which can be actuated by the safety control for separating at least one component of the fuel cell system from the electrical energy source.

Vehicles with fuel cell propulsion require, in particular, when the fuel is hydrogen, devices in order to switch off the fuel supply in the case of gas leakages, in order to avoid the collection of gas in the vehicle. This function is achieved by components in the form of sensors, logic circuits, optionally of a microprocessor and at least one switch-off device.

The so formed electronic safety system, which is made autark has the task of switching off the supply of fuel from the fuel container to the fuel cell stack and of switching off any eventually present electrical storage devices such as for example a high voltage battery and in particular when a gas leakage is detected at one or more points of the vehicle or when an accident is detected, for example through the forces acting on the bodywork or chassis, which can be detected with acceleration sensors, for example in the form of piezo-electric sensors. The safety system can, if necessary, also react to other critical states, such as for example critical temperatures, critical pressures or critical voltage levels which arise outside of the respectively provided working ranges. Furthermore, critical states in other components or subsystems of the fuel cell system can be taken into account by the safety system.

### SUMMARY OF THE INVENTION

A safety system for use in a vehicle having a fuel cell system, a fuel supply means, an electrical energy source, said fuel cell system having at least one component connectable to said electrical energy source, a plurality of sensors associated with said fuel cell system and adapted to deliver safety relevant signals and a safety control for said fuel cell system, said sensors being connected to said safety control, said fuel cell system having at least one device for switching off said fuel supply means and also at least one device which can be actuated by said safety control for separating said at least one component from said electrical energy source, there being furthermore an airbag system having at least one airbag, at least one gas generator associated with said airbag for the inflation thereof, an airbag control controlling said gas generator, a plurality of sensors, a circuit connecting said sensors to said airbag control and adapted to deliver safety relevant signals for the triggering of said airbag, said safety control of said fuel cell system being one of connected to said airbag control and functionally replaced by said airbag control.

The invention is thus based on the recognition that all vehicles belong to the current state of the art are equipped with airbag systems. The number of the airbags and also the number of sensors which are required in order to realize the respective triggering strategy are permanently increasing. Current systems are based on a centralized architecture of the airbag system. In this respect a plurality of sensors and the airbags are connected to one airbag control. This already leads to an increase in the cost of wiring and also the complexity of the wiring harness and forces car manufacturers to develop systems equipped with communication buses. In this case all the sensors and actuators for the airbags are connected to a high speed communication bus.

Since the airbag systems used nowadays and the corresponding airbag controls are already very powerful it has been recognized, in accordance with the invention, that the safety system associated with the fuel cell system can also be integrated into the airbag control or combined with the airbag control system, whereby the system, when considered over the vehicle as a whole, becomes more price-worthy and is at least as powerful if not more powerful than previously.

When a centralized architecture is realized for the airbag system, i.e. for the airbag control, the safety system associated with the fuel cell system can be integrated into this architecture. Also, when an architecture is present which is based on a communication bus the safety system associated with the fuel cell system can likewise be integrated into this system.

### BRIEF DESCRIPTION OF THE DRAWINGS

The invention will now be described in more detail in the following with reference to embodiments and to the drawings in which are shown:

FIG. 1 is a schematic side view of a part of an internal compartment of a motor vehicle which has an airbag system and also a fuel cell system as a source of propulsion;

FIG. 2 is a schematic representation of a first safety system in which an airbag control sands in association with a safety system for a fuel cell system;

FIG. 3 is a further embodiment of a safety system in which a safety system of a fuel cell system is further integrated with an airbag control;

FIG. 4 is a detailed possible design of the control of the embodiment of FIG. 3; and

FIG. 5 is a bus system which can be used in accordance with the invention when the individual sensors are provided with digital outputs.

### DESCRIPTION OF THE PREFERRED EMBODIMENT

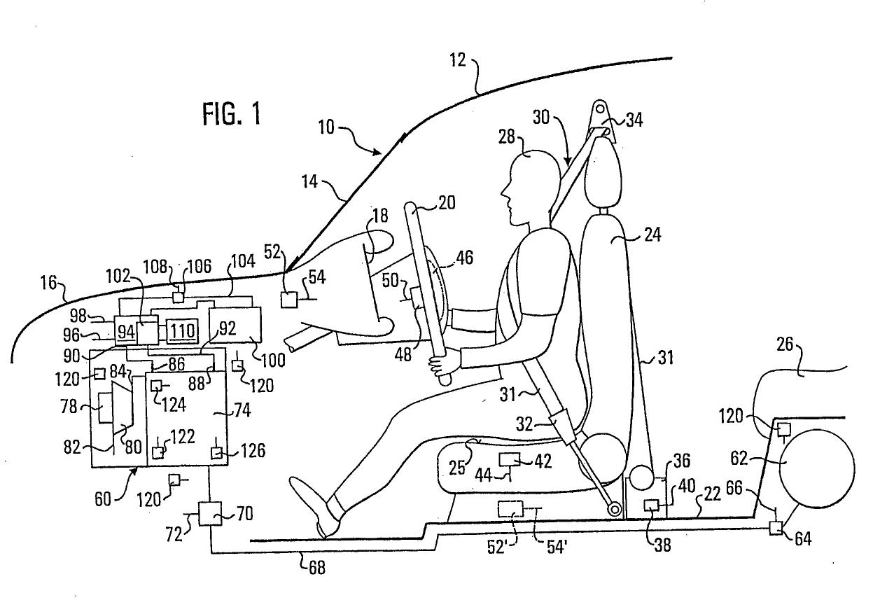

Referring to FIG. 1 a part of a motor vehicle 10 is shown there having a roof 12, a windscreen 14, a hood 16, an instrument panel 18, a steering wheel 20, a floor group 22, a front seat 24 and a rear bench seat 26. For the sake of illustration many components of the motor vehicle such as for example the wheels and the wheel suspension and also the doors and the rear part of the car have been omitted, in order to unnecessarily complicate the drawing.

Furthermore, it should be emphasized that the present invention is in no way restricted to vehicles with a roof 12 and a rear bench seat 26 but can rather be used for all types of vehicles such as sport cars without a roof and cars with only two seats.

In the illustration of FIG. 1 the driver 28 is seated on the vehicle seat 24 and is held during the journey by a belt system 30. The belt system, which can be designed as a two point, three point or multi point belt includes a belt part 31 which leads from a belt lock 32 via a deflection device 34 to a belt reeling mechanism 36, with the belt reeling mechanism 36 being provided with a belt tensioner which can be driven by a gas generator 38 in so far as the gas generator is triggered via the line 40. A weight measuring sensor 42 is located under the seat surface 25 and is connected via a line 44 to an airbag control, which is not shown in FIG. 1.

A driver airbag 46 is located within the steering wheel and can be inflated from a gas generator 48 when this is triggered via the line 50. The line 50 is also connected to the airbag control (not shown). The vehicle has at least one acceleration sensor 52 which in this example is installed behind the instrument panel and is likewise connected to the airbag control via a line 54. Instead of mounting the acceleration sensor 52 at the instrument panel it can, for example, be installed at the middle of the floor group 22, as is shown in broken lines at 52′ and 54′ in FIG. 1.

Although only one airbag 46 and one weight measuring sensor 42 are provided in this figure further airbags can be provided, for example an airbag for the passenger adjacent to the driver, airbags for the passengers on the rear seats, side airbags, etc. Furthermore, in addition to the acceleration device 52 or 52′ which measures the longitudinal acceleration of the vehicle a measurement sensor for the transverse acceleration can also be provided. Moreover, in manner known per se other accident detection sensors can be provided, for example sensors which are provided in the longitudinal direction of the vehicle at both sides in order to determine the position of an impact and to effect the inflation of the airbag accordingly via the airbag control. The airbag system can include all variants known in the prior art.

In the prior art the most diverse proposals have been made for the design of airbag controls which can in principle all be combined with a safety control for a fuel cell system for the purpose of the present invention. For example DE-OS 197 32 302 A1 describes a collision sensor arrangement for motor vehicles for the detection of accidents and for the control of safety components, with the collision sensors being designed as piezo-electric foils which are arranged in areal manner at positions at the side of the vehicle which are endangered by the collision.

Furthermore, the international patent application with the publication no. WO 98/52795 describes an occupant protection control system with two occupant protection control devices, in particular a front airbag control device and a side airbag control device, with the one occupant protection control device containing, in addition to a non-volatile memory, a further memory, in which the sensor data of the other occupant protection control system are continually recorded, said data being monitored for the detection of a possible accident and being transmitted by the other occupant protection control apparatus. When an accident is detected, the data are transferred from the further memory into the non-volatile memory in which the accident relevant data detected by this occupant protection control device are also permanently stored.

EP 0 965 500 A2 describes an airbag apparatus which permits the quantity of gas supplied into the gas cushion to be controlled. EP 0 949 127 B1 describes a similar system in which at least one sensor element functioning as a sensing medium and responding to a local pressure change is arranged at the side of the gas cushion moving towards the occupant, by which the sensor signal which characterizes the pressure change that is detected can be produced and can be directed to the control device which controls the filling means.

EP 1 147 945 A2 and also DE 100 19 590 A1 describe a control apparatus and a method for triggering an airbag, in particular for single track vehicles, with a control device which, in order to avoid a faulty triggering of the airbag, provides a sensor for the detection of the rotation or a deceleration of the front wheel, with the control device being designed to permit airbag triggering in addition to at least one other condition when the front wheel is retarded to zero when the brake is not actuated or when the brake is activated and the anti-blocking system is activated.

EP 1 114 756 A2 is concerned with a problem which arises with airbags and which lies in the fact that the triggering and the inflation process of the airbag must be matched to the distance of the person to be detected from the airbag and the presences of other objects, for example a child's seat. A system for the control of the triggering of an airbag is proposed which has a transmitter means for the transmission of radiation into a space associated with the airbag and a receiver device with a plurality of sensor elements for the detection of radiation thrown back from an object present in the space, from which the position of the object within the space can be found. The output signals of the sensor elements are individually evaluated with respect to predetermined conditions being satisfied and, if the predetermined conditions are not satisfied, are not taken into account in the determination of the position.

EP 0 922 616 B1 describes an airbag system which makes the inflation of the airbag dependent on whether the vehicle occupant to be protected is wearing a safety belt.

DE 199 63 348 A1 is concerned with a method for the determination of the position of a force acting on a vehicle in which the technical problem of recognizing the vehicle under-floor as the source of a vibration and preventing false triggering of the airbag is solved by a method in which, with the aid of at least three sensors arranged spaced apart from one another in the vehicle, the time at which the force acts is measured and information is calculated from the transit time differences from the measurement signals.

DE 198 22 850 A1 describes the control of the quantity and direction of a gas to be introduced into an airbag in dependence on the position of the body region and of the face region of the driver or passenger adjacent to the driver. The detection of the position takes place through the production of a thermal image of the driver or passenger adjacent to the driver.

DE 197 19 455 A1 describes a sensor circuit for airbag control with a circuit carrier and a sensor foil which overlap one another in the sensor foil attachment zone. In this way the number of electrical interfaces between the sensor foil and the wiring loom connection can be reduced so that a high electrical contact reliability results.

DE 196 10 833 A1 describes an apparatus for the control of an occupant retention system, such as for example an airbag and has sensors in order to sense at least two parameters which could impair an occupant retention function of the retention system. The sensors are connected to a controller which selects one of a plurality of discrete control zones and makes the control signal available on the basis of the selected control zone.

DE 101 52 770 A1 describes a seat weight sensing system for the control of the activation of an airbag which is matched to a seat of a vehicle and has an airbag control module, with the seat weight sensing system including a weight sensor which is associated with the seat and can measure a total mass on the seat. In this system the safety belt tension is also measured and taken into account during the unfolding of the airbag.

DE 100 43 100 A1 describes a method for the control of the inflation of an airbag which takes account of the environmental temperature and takes account of the pressure build-up behavior of the airbag in dependence on the temperature.

DE 44 06 499 A1 describes a sensor unit for the control of an airbag with a sensor which is kept in its position on a circuit board by an elastic damping retainer.

DE 198 40 440 A1 describes a method and an apparatus for the control of an occupant protection means of a vehicle in which the mass of the vehicle and a dependency between a deformation of the bodywork and of the work which has to be performed for this deformation. The actual bodywork deformation which takes place during an accident is determined in dependence on a recorded acceleration, the work and the vehicle mass are determined and the occupant protection means is controlled in dependence on the actual bodywork deformation or a parameter derived therefrom.

DE 198 30 835 A1 describes a method for the triggering of a retention means for side impact protection in a vehicle in which a pressure signal is delivered by a pressure sensor arranged in a vehicle side door.

DE 198 35 561 A1 is concerned with a method and an apparatus for the trigger control of at least one airbag by means of a number of pressure sensitive sensors which are preferably arranged in or on deformation elements and/or additional carriers along a side region and/or a front and/or rear region of a motor vehicle.

DE 100 18 985 A1 describes an arrangement for the control of the triggering of at least one airbag in dependence on the position of an impact.

A fuel cell system 60 which receives a fuel, normally hydrogen, from a hydrogen tank 62 via a flow valve 64 with a control line 66 and a fuel supply line 68 serves as a source of propulsion for the vehicle of FIG. 1. In this example the hydrogen tank is disposed beneath the floor group 22 in the region of the rear bench seat 24. This is however not essential. It is also not essential for the fuel cell system 60 to be arranged beneath the hood 16 of the motor vehicle.

In this example, the valve 64 is a shut-off valve which opens when the vehicle is taken into use and is switched off when driving is ended or in the event of an accident in order to shut-off the fuel supply from the hydrogen tank to the fuel cell system. The reference numeral 70 indicates a further valve with a control line 72 which is designed to regulate the supply of fresh fuel to the fuel cell system.

In practice a plurality of valves are frequently incorporated into the fuel supply line 68, such as is for example described in the German patent application 102 00 058.1. In the present case it would also be conceivable to provide a second switch-off valve in the fuel supply line 68 which is arranged directly in front of the fuel cell stack 74. In the case of an accident both the switch-off valve 64 and also the further (non-shown) switch-off valve are then actuated. This has the advantage that not only is the escape of hydrogen from the hydrogen tank prevented, but rather, in the case of an accident, also a loss of hydrogen which is present under pressure in the line 68 and in the units associated with it.

Although the switch-off valve 64 is arranged in this drawing close to the source of hydrogen 62 it could also be provided at a different point in the line 68.

Furthermore, it is conceivable not only to provide the valve 64 as a shut-off valve but rather to design it so that a regulating function is also possible. In this way it would in principle be possible to operate with only a single valve between the hydrogen tank and the fuel cell stack. The details of a possible design of the fuel cell system with the valves associated with it for the control of the fuel supply is to be found in the German patent application 102 00 058.1.

For the operation of the fuel cell stack 74, which normally consists of a plurality of low temperature PEM fuel cells connected in series and/or in parallel to one another, the supply of oxygen is necessary. This is usually achieved in the form of atmospheric oxygen from a compressor 80 driven by an electric motor 78 and having an air inlet 82 and an air outlet 84. In continuous operation the fuel cell system 60 or the fuel cell stack 74 produces electrical energy with an operating voltage arising at the terminals 86 and 88 of the fuel cell stack. This voltage is supplied via lines 90 and 92 respectively to an inverter 94 which drives the electric motor 78 via the lines 96 and 98.

The reference numeral 100 designates a low voltage battery which, on starting up of the fuel cell system 22, supplies the inverter 94 via a DC-DC converter 102 with electrical energy for the driving of the electric motor 12. The low voltage battery 100 is connected to a low voltage bus 104 for the on-board electrical system of the corresponding motor vehicle and delivers via this low voltage bus 104 (after closing of the switch 106 via an appropriate control line 108) the appropriate electrical power to the DC-DC converter 102. The latter delivers an upwardly transformed voltage to the inverter 94 and this then serves via the lines 96 and 98 for the driving of the electric motor 78.

Through the supply of fuel and atmospheric oxygen to the fuel cells of the fuel cell stack 74 the latter produces a DC voltage which is present at the terminals 86 and 88 and which is subsequently available to the inverter 94, so that the upward transformation of the power of the low voltage battery in the DC-DC converter 102 is omitted shortly after the vehicle has started.

The AC voltage present at the lines 96, 98 is not only used for the driving of the compressor 80 but is also available for the drive motors of the motor vehicle, which drive the wheels, and also for other units.

Furthermore, a high voltage battery 110 can be provided. Depending on the output voltage of the high voltage battery 110 the transformation required by the DC-DC converter can be made smaller. When the output voltage at the terminals 86, 88 is too low in order to produce a desired AC voltage in the inverter this voltage is first applied to the DC-DC converter 102 and brought to a higher voltage level before the output voltage is applied to the inverter 94.

Furthermore, the possibility exists, on provision of a high voltage battery, to dispense with the low voltage battery and to operate the on-board electrical system via a part of the output voltage of the high voltage battery. Hydrogen sensors 120 which can determine hydrogen leakages are provided at critical points in the vicinity of the fuel cell system and also of the fuel tank. These hydrogen sensors 120 are connected, as will be explained subsequently in more detail, to the safety control system. Moreover, a temperature sensor 122 and also an air pressure sensor 124 and a pressure sensor 126 for the hydrogen pressure at the anode side of the fuel cell stack are provided.

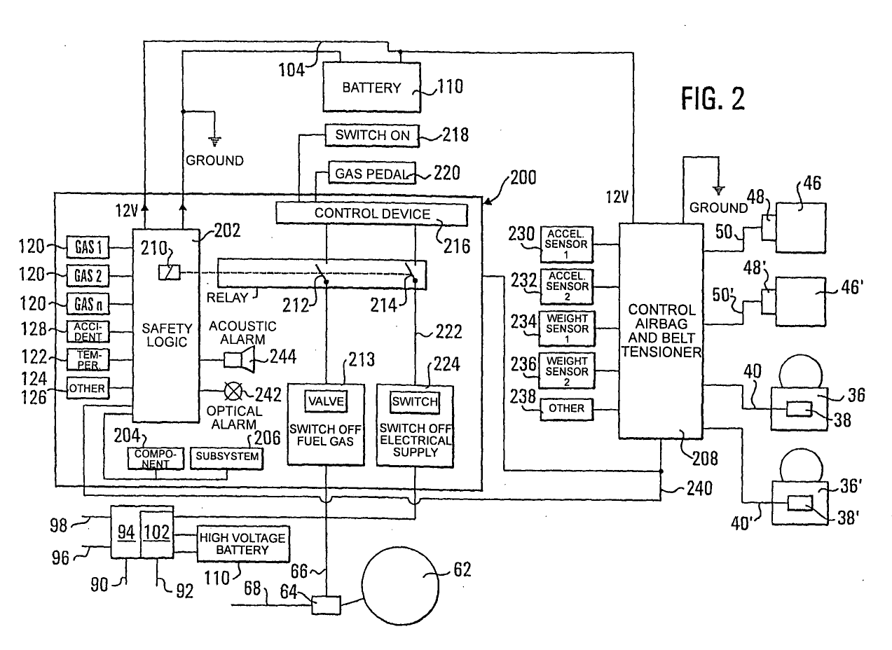

Since the basic design of a vehicle with an airbag system with belt tensioners and also with a fuel cell system as the power plant together with various possible variants of this vehicle have been described a first possibility for the integration of the fuel cell safety system with the airbag system will now be described in accordance with the invention in more detail with reference to FIG. 2.

Referring to FIG. 2 a safety system is first shown in the box 200 which is known per se for use with a fuel cell system. In accordance with this the hydrogen sensors 120 which are designed to detect hydrogen leakages are connected, together with a temperature sensor 122 and other relevant sensors, such as for example an air pressure sensor 124 for the air pressure at the cathode side of the fuel cell stack and a pressure sensor 126 for the hydrogen pressure at the anode side of the fuel cell stack, to a safety logic 202. Furthermore, other safety critical components or subsystems of the fuel cell system can be connected to the safety logic 202 as indicated by the boxes 204 and 206. Although the boxes 204 and 206 are connected to the safety logic 202 via a common lead they could also be connected to it via separate leads. By way of example the subsystem could be the cooling system for the fuel cell stack, with the conductivity of the coolant representing a critical parameter. Should this rise impermissibly, it could lead to faulty functioning in the fuel cell stack which is why this conductivity should be monitored, as is for example described in the German patent application 101 28 836.0. One critical component would also be the circulation pump for the cooling system. If this pump were to fail then this would lead, in the same way as a failure of a fan associated with the cooling system, to overheating of the fuel cell stack.

Furthermore, FIG. 2 shows an accident sensor 128 which would be connected in the prior art to the safety logic. This sensor can be omitted in accordance with the invention since it has become superfluous with the coupling of the safety logic 202 to the airbag control 208, as will be explained in more detail in the following.

The sensors, switches or other components and subsystems which are connected to the safety logic 202 can feed analogue signals or binary signals into the safety logic. The safety logic itself can be equipped with discrete electronic components or can include a microprocessor system. The object of the safety logic consists in comparing the in-going signals with predetermined alarm thresholds. Should one of the signal inputs lie outside of a respectively predetermined range than this leads to one or more output signals which actuate the relay 210 whereby, in the case of a serious disturbance the normally closed switch 212, 214 is opened.

The starting of the vehicle will now be explained briefly. The reference numeral 216 designates the control device which is normally provided in order to put into effect the commands of the driver. The control device 216 receives a switch-on command, for example from a switch-on device 218.

After the vehicle has been switched on, for example by means of a key actuated by the driver, the valve 64 is switched on via the control device 216, the closed switch 212 and the line 66 so that fuel gas can be supplied from the fuel tank 62 via the fuel line 68 to the fuel cell stack 74 in accordance with FIG. 1. The box 213 is to be understood as a functional box and the “VALVE” addressed there is to be equated with the valve 64.

At the same time the electric motor 78 is driven in the manner known per se in order to supply air to the fuel cell stack via the compressor 80. In order to bring about the driving of the electric motor 78 the switch 224 is closed via the switch 214 from the control device 216 via the control line 222, whereby the high voltage battery 110 is connected to the DC-DC converter 102. Should the high voltage battery 110 not be present and the DC-DC converter be fed from the low voltage battery 100 then, instead of the switch 224 being closed via the control line 222, the switch 106 in FIG. 1 is closed via the control line 108 shown there, whereby the low voltage battery 100 is connected to the DC-DC converter 102. If both a low voltage battery and also a high voltage battery are provided then both switches 224 and 106 are actuated via the corresponding control lines 222 and 108. In this manner it is ensured that the electric motor 78 receives via the inverter 94 the respectively provided drive power in order to produce the power respectively required for the driving of the compressor 80.

With the simultaneous supply of hydrogen and air protons from the hydrogen and atmospheric oxygen are catalytically combined in known manner in the fuel cell stack 74 and a voltage is produced which appears at the terminals 86, 88 and is used for the propulsion of the vehicle and also for the driving of various aggregates associated with the fuel cell system.

In a fuel cell vehicle the driver also has an accelerator panel 220 and can, on actuation of the accelerator pedal, control the quantity of the fuel gas supplied to the fuel cell stack and thus also the electrical power generated by the fuel cell stack, which is available for the driving of the units associated with the fuel cell stack and also for the propulsion of the vehicle. The control device 216 takes care, via non-illustrated lines, of an appropriate control of the fuel cell system. For example, the quantity of the fuel supplied via the valve 70 to the fuel cell stack 74, the electrical power which is made available to the motor 78 and also the cooling power of the coolant circuit are controlled in order to ensure the respectively desired operating state of the vehicle.

As mentioned above, the airbag control 208 is provided for the airbag and belt tensioner system. This has, in this example, five inputs; namely an input 230 from a first acceleration sensor (e.g. 52 or 52′ in FIG. 1), an input 232 from a transverse acceleration sensor (the sensor itself is not shown), an input 234 from a first weight measuring sensor 42 for determining the weight of the actual driver, an input 236 from a second weight sensor (not shown), for example for measuring the weight of the passenger adjacent the driver and an input 238 from other sensors. Such other sensors can, for example, be sensors which have been mentioned above in connection with the prior art, e.g. switching elements provided at the longitudinal sides of the vehicle which are provided to determine the respective location of the input in order to correspondingly trigger the side air bags.

The internal construction of the airbag control in the box 208 can in principle correspond to the internal construction of the safety logic in the box 202. That is to say it can consist of discrete electronic components and/or it can contain a microprocessor with corresponding memories. The signals which come from the sensors can here also be analogue signals or signals in binary form. When the output signals of the sensors are present in binary form, i.e. only the values 0 or 1 are permitted, then the safety logic can be realized by logic components known per se which link the input signals and then control the relay 210 when an output signal or a plurality of output signals indicate a dangerous state. For example the value 1 can point to a non-dangerous state and the value 0 to a dangerous state, such as for example that a hydrogen leak is present or a dangerous temperature is present or an accident has happened.

The airbag control is designed to process the signal inputs 230 to 238 and serves to trigger the individual airbags, such as 46 for the driver and 46′ for the passenger adjacent to the driver and also the respective belt tensioners 36 for the driver and 36′ for the passenger adjacent the driver. When further airbags are provided these airbags can also be intentionally triggered by the airbag control 210 in dependence on the signal inputs, that is to say the gas generators for all further airbags are connected to the airbag control 208.

In accordance with the system of FIG. 2 the signals processed in the airbag control 208 were passed from the acceleration sensors via the line 240 to the safety logic 202 and thus replace the accident sensors 128. That is to say that the processed signals of the acceleration sensors (or of the acceleration sensor, if only one such sensor is provided) are supplied to the safety logic 202 and, in the same way as signals of the gas sensors 120 or of the temperature sensor 122, or other inputs 124, 126, lead to the triggering of the relay 210 whereby the switches 212 and 214 are opened.

When the switch 214 is opened, then no voltage is any longer present at the switch 224, as mentioned above. This switch is designed so that it opens automatically and thus automatically decouples any high voltage battery 110 which is present from the DC-DC converter. The decoupling of the low voltage battery 100 from the vehicle can take place in the same way and means but may first take place when the safety systems of the vehicle have been actuated in accordance with the accident, that is to say switching off of a low voltage battery 100 may only take place after a preset delay.

On opening the switch 212 the voltage which was present at the control line 66 is removed from the solenoid valve 64 whereby this valve in turn switches and prevents a further supply of the fuel from the fuel tank 62. This valve is a valve which is closed in the current-free state. Should a second valve 70 likewise have a switch-off function then here the corresponding voltage is also removed on opening of the same switch or of a further switch, whereby this valve also closes.

Basically the number of switches such as 212, 214 which are actuated by the relay 210 can be increased as desired whereby, when one of the signal inputs to the safety logic falls outside of the predetermined range, or when a signal from the airbag control 208 is passed on to the safety logic in order to announce an accident which is taking place, one or more output signals can overrun the vehicle control signals or switch them off. In this way relevant gas flows can be switched off and electrical power can be removed from the valves so that these adopt a position ensuring secured safety under dangerous circumstances. Electrical voltage sources can also be switched off and relays which are to adopt a position ensuring security in a voltage-free state can be made current-free.

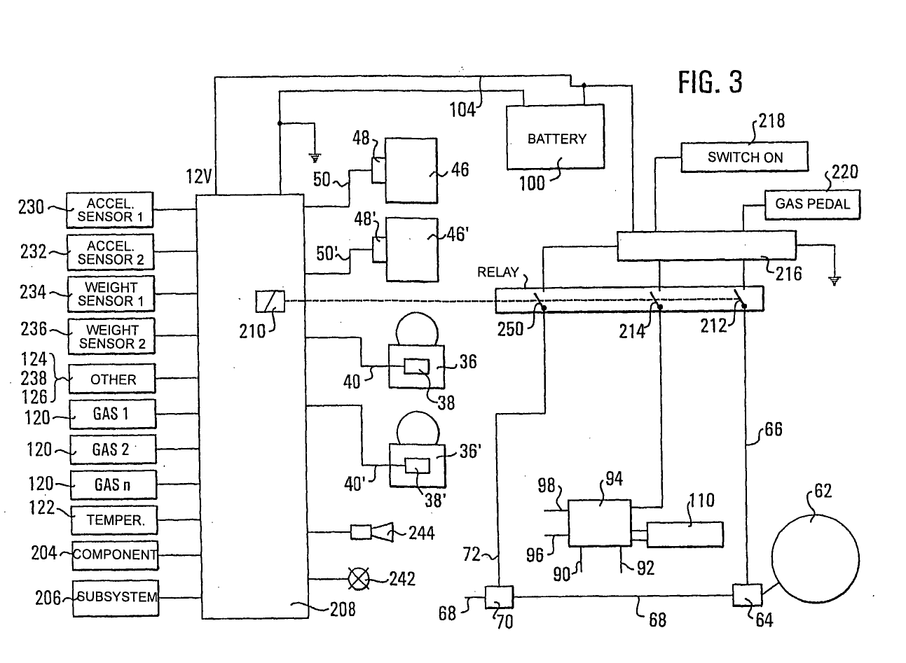

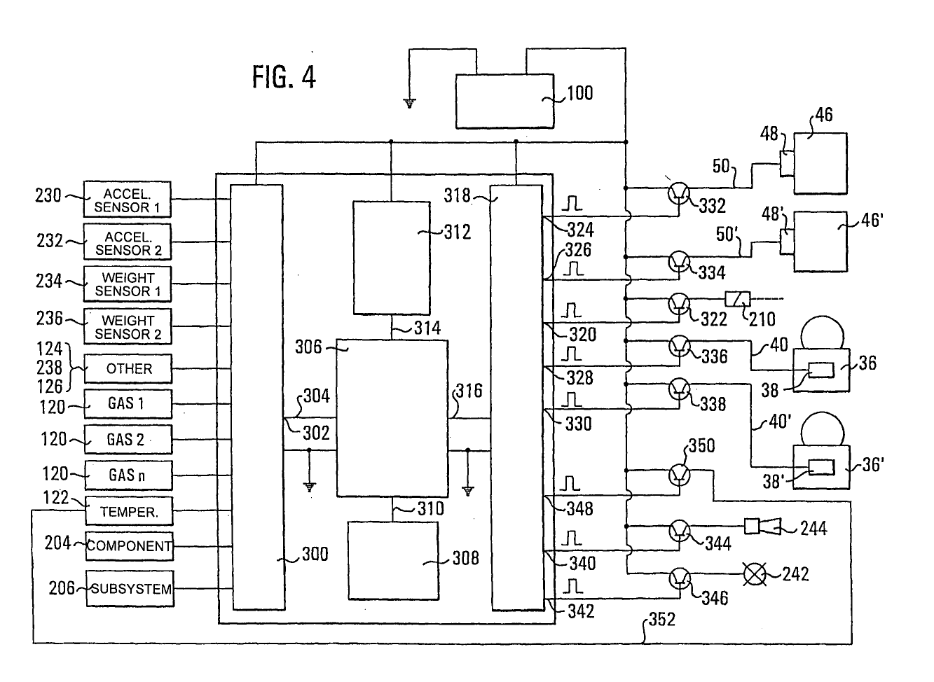

When the safety logic 202 of the fuel cell system and/or the airbag control 208 coupled with it have a microprocessor control available, then, as will later be described in conjunction with the embodiment of FIGS. 3 and 4, additional functions such as sensor diagnosis, self checking of sensors, remote calibration and data exchange with other control systems can be realized. For example, all sensors and at least critical sensors can be checked at regular time intervals in order to ensure that they are capable of operating. Some sensors have self-diagnosis possibilities and can, when carrying out such self-diagnosis, transmit corresponding confirmations to the safety logic or to the airbag control. Furthermore, there are sensors which have to be calibrated and the required calibration processes can be triggered and carried out by a microprocessor control which is present. The exchange of data with other control systems is also possible. For example, the temperature sensor 122 can be used for the purpose of the control of a fuel cell system, for example in conjunction with a control system such as is described in the German patent application 101 46 943.8. In this case the corresponding data and temperature signals can be fed via the microprocessor control to the control system for the fuel cell system.

Since the switching off of the fuel cell system can simply take place when only the fuel cell system has a fault and no accident has happened, it is appropriate to provide an acoustic and/or alarm possibility which warns the driver of the vehicle when switching off of the fuel cell system has taken place or is to be shortly expected as a result of faulty functioning. These two possibilities of an optical alarm and of an acoustic alarm are indicated by the reference numerals 242 and 244 in FIG. 2.

When the sensors 120, 122, 124, 126, 204, 206, 230, 232 und/or 238 deliver binary output signals, i.e. only permit two values 0 or 1, then the processing in the safety logic 202 and/or 208 can take place in such a way that if a sensor now delivers a value 0 or 1 which points to a faulty function the relay 210 is actuated via the control 202. The weight sensors 234, 236 can also be designed to produce binary output signals, with for example the value 0 pointing to the fact that the corresponding seat is empty whereas, with the value 1, it is assumed that a person is present on the seat. In the event of an accident, only that airbag and belt tensioner is then actuated in which a person can meaningfully be protected, i.e. only those airbags and belt tensioners in which the associated weight sensor indicates the presence of a person on the associated seat.

Furthermore, FIG. 2 shows that the safety logic 202 and the airbag control 208 can be provided with a 12 V voltage from the low voltage battery 110. Other voltages can also be considered when the safety logic 202 or the airbag control 208 make this necessary.

FIG. 3 now shows a further development of the embodiment of FIG. 2 in which the airbag control 208 and the safety logic 202 are combined. The corresponding control is now provided with the reference numeral 208.

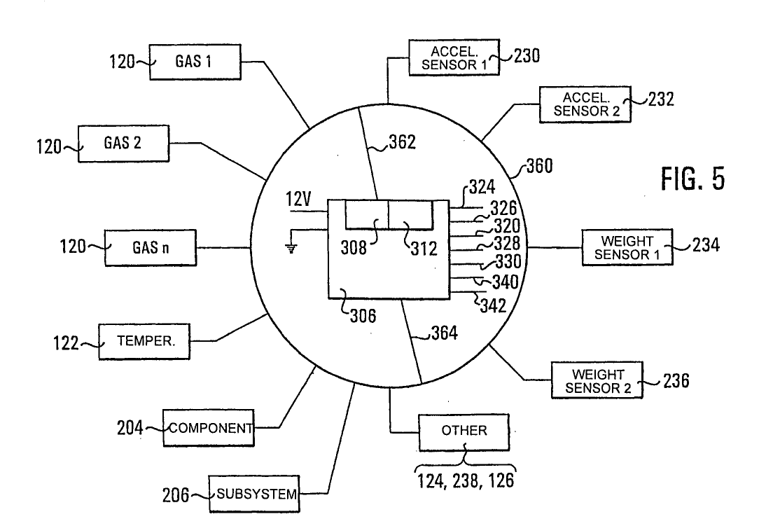

The other reference numerals used in FIG. 3 are the same as are used in FIG. 2 and it will be understood that the previous description also applies to parts with the same reference numerals unless something to the contrary is stated. This also applies to the further description in conjunction with the FIGS. 4 and 5.

One can see from FIG. 3 that by combining the safety logic and the airbag control into a unit 208 one of the two main components can be dispensed with. For this purpose the remaining control 208 must admittedly be made somewhat more powerful. This is however straightforwardly possible with a substantial cost saving in total.

Function-wise the circuit of FIG. 3 equates with the circuit of FIG. 2 but has however an additional function in that the valve 70 can be controlled here specifically via its own switch 250 via the control line 72. The valve 70 can in this way also be switched off, in the event of an accident or in the event of switching off of the fuel cell system for another reason, whereby a gain in safety is achieved.

For the embodiment of FIG. 3 it is in other respect the case that this system can also be developed in the sense that several airbags such as for example side airbags and head airbags and airbags for passengers on a rear bench seat 26 can be provided and can all be controlled from the control unit 208.

Belt tensioners can also be provided for the rear seat passengers. Other valves or voltage source can also be switched off here by the provision of further switches which are actuated by the relay 210. It is likewise conceivable to provide further relays for such switching off purposes, i.e. not all switches must be actuated from one relay. This also applies to the embodiment of FIG. 2.

It is also the case here that sensors can deliver analogue signals or binary signals and that the programming of the microprocessor can also enable functions such as sensor diagnosis, self diagnosis of sensors, remote calibration and data exchange with other control systems.

FIG. 4 now shows a possible design of the control 208 in FIG. 3 which can however also be used with appropriate modification for the safety logic 202 in FIG. 2 or for the airbag control 208 in FIG. 2.

In the embodiment of FIG. 4 it is first assumed that the various sensors 230, 232, 234, 236, 124, 238, 126, 120, 122 and also the component 204 and the subsystem 206 deliver analogue signals. These signals are all applied to an analogue/digital converter 300 in combination with a multiplexer, with the digital output 302 of the multiplexer communication via a bus line 304 with a microprocessor 306. The microprocessor 306 defines a clock signal with which the inputs of the different sensors can be scanned in turn and the corresponding signal supplied after analogue/digital conversion to the computer 306 via the bus line 304. The microprocessor 306 evaluates the digitized output signals of the sensors in accordance with predetermined programs which are deposited in the memory 308, with which the microprocessor 306 communicates via a further bus line 310.

The reference numeral 312 points to a working memory with which the microprocessor 306 communicates via a further bus line 314. The microprocessor 306 can for example store calculated computing results in the memory 312, at least for a specific time interval, so that in the case of switching off of the fuel cell or of an accident a protocol is available concerning the results directly prior to switching off or directly prior to the accident.

When the working result of the microprocessor 306 makes it necessary to switch off the fuel cell system, then a digital switch-off signal is passed on by the microprocessor 306 via the further bus line 316 to a multiplexer 318 and applied via the output 320 to the base of a transistor 322 which is made conductive and applies a potential originating from the battery 100 to the relay 210 which then takes care of the actuation of the corresponding switches such as 212, 214 and 250. In this manner the switching off of the fuel cell system takes place as previously described. With appropriate design of the circuit the process could also take place in such a way that the transistor is closed and the relay 210 is made current-free, with the relay likewise having to open the switches 212, 214 and 250 in the current-free state.

Should the result of the work of the microprocessor show that an accident is in the process of taking place, then corresponding control signals are applied via outputs such as 324, 326, 328 and 330 to the basis of further transistors 332, 334, 336 and 338 which then apply potential from the low voltage battery 310 to the respective gas generators 48, 48′, 38, 38′ via the respective control lines 50, 50′, 40 and 40′ and thus take care of the inflation of the airbag and the actuation of the belt tensioners. The corresponding signals do not all have to take place simultaneously but can rather also take place in time sequence so that, for example, the belt tensioners are actuated before the respective airbag is inflated.

When further airbags or belt tensioners are provided then these can be actuated in corresponding manner from the processor 306 via the multiplexer 318 and corresponding further transistors (not shown).

On switching off the fuel cell system control signals can furthermore be applied via the outlets 340 and 342 to the bases of two further transistors 344 and 346, whereby the acoustic alarm 244 and the optical alarm 242 are actuated.

The reference numeral 348 points to a further output of the multiplexer 318 which applies a diagnosis signal via a further transistor 350 and a line 352 to a sensor, in this case the temperature sensor 122. On receiving the diagnosis signal the temperature sensor produces an output signal and this is detected and evaluated via the multiplexer/AD converter 300, the output 302 and the bus line 304 by the microprocessor 306. For all sensors which can be checked with respect to their ability to operate, or which are to be calibrated, corresponding outputs can be provided at the multiplexer 318 and the corresponding checks with respect to their ability to function and the corresponding calibration can be effected.

Should the sensors 230, 232, 234, 236, 124, 238, 126, 120, 122 or the component 204 or the subsystem 206 be modules which have a digital output than the analogue/digital converter can be omitted and the corresponding signals can be directly read into the microprocessors 306 via a multiplexer. Should only some of the named sensors, that is to say the component 204 or the subsystem 206 have a digital output, then an analogue/digital converter can be provided for the processing of the analogue signals of the other sensors and the digitized output signals with the digital output signals can then communicate with the microprocessor 306 via the multiplexer 300.

All components such as 300, 306 and 318 received the required operating voltage from the battery 100 via the lines which are drawn in in FIG. 4. Furthermore, all parts are connected via corresponding earth connections to ground. The required voltages for the memory 308 and the working memory 312 are applied to these by the microprocessor 306 via the bus lines 310 and 314 respectively.

Furthermore, the possibility exists, with sensors or components or subsystems with digital connections of providing these with calibration signals directly from the microprocessor 306 which then lead directly from the corresponding outputs of the multiplexer 318 to the respective component. Here appropriate reply signals to the microprocessor 306 can take place via the multiplexer 300.

Finally FIG. 5 shows a different architecture in which all sensors, components and subsystems 230, 232, 234, 236, 124, 238, 126, 120, 122, 204 and 206 are formed as sensors or components or subsystems with a digital output. These digital outputs are all connected to a bus line 360 which is here formed as a ring line, with this ring line being connected via two branch lines 362, 364 to the microprocessor 306, in this case with integrated memory 308, 312. Each sensor, each component and each subsystem which is connected to the ring line 360 has its own address which is sent with the respective output signal to the bus line. The microprocessor 306 can recognize, as a result of these addresses, which signal is received from which sensor, component or subsystem and can process these signals accordingly and then control the corresponding devices in FIG. 4 via the corresponding outputs 324, 326, 320, 328, 330, 340 and 342. An output such as 348 in FIG. 4 is however not required in this embodiment, since the microprocessor 306 can directly communicate with respective sensors, components and subsystems via the bus line.

FIG. 5 is only one example for a bus line. The bus line can be designed in accordance with any desired known pattern. It need only be ensured that the bus protocol permits a sufficiently rapid signal processing and, in the event of a fault or in the event of an accident, timely triggers all required measures.

The concept of the invention can also be used with vehicles which are equipped, instead of a fuel cell system, with another power source operating with a fuel gas such as hydrogen or propane, for example with a power source in the form of a combustion engine. This possibility is taken into account in independent claim 25. In an embodiment of this kind, in which a combustion engine is used instead of the fuel cell system, a safety system is provided in order to detect gas leakages and to switch off the drive source. That is to say that gas sensors area arranged at critical points in the vehicle or in the vicinity of the combustion engine, precisely as in a fuel cell vehicle. Other relevant sensors, such as a temperature sensor can also be provided. With such a power source it makes sense to switch-off electrical sources of energy and to remove the operating voltage from relays which, in the voltage-free state, adopt a switch position ensuring the safety.

1. A safety system for use in a vehicle comprising a fuel cell system, a fuel supply means, an electrical energy source, said fuel cell system having at least one component connectable to said electrical energy source, a plurality of sensors associated with said fuel cell system and adapted to deliver safety relevant signals and a safety control for said fuel cell system, said sensors being connected to said safety control, said fuel cell system having at least one device for switching off said fuel supply means and also at least one device which can be actuated by said safety control for separating said at least one component from said electrical energy source, an airbag system having at least one airbag, at least one gas generator associated with said airbag for the inflation thereof, an airbag control controlling said gas generator, a plurality of sensors, a circuit connecting said sensors to said airbag control and adapted to deliver safety relevant signals for the triggering of said airbag, said safety control of said fuel cell system being one of connected to said airbag control and functionally replaced by said airbag control.

2. A safety system for use in a vehicle comprising a fuel cell system, a fuel supply means, an electrical energy source, said fuel cell system having at least one component connectable to said electrical energy source, a plurality of sensors associated with said fuel cell system and adapted to deliver safety relevant signals and a safety control for said fuel cell system, said sensors being connected to said safety control, said fuel cell system having at least one device for switching off said fuel supply means and also at least one device which can be actuated by said safety control for separating said at least one component from said electrical energy source, an airbag system having at least one airbag, at least one gas generator associated with said airbag for the inflation thereof, at least one safety belt with a belt tensioner, an airbag control controlling at least one of said gas generator and said belt tensioner, a plurality of sensors, a circuit connecting said sensors to said airbag control and adapted to deliver safety relevant signals for the triggering of said airbag and said belt tensioner, said safety control of said fuel cell system being one of connected to said airbag control and functionally replaced by said airbag control.

3. A safety system in accordance with claim 2, wherein said circuit comprises at least one data bus to which all sensors, the airbag control, the gas generator, the belt tensioner, the device for the switching off of the fuel supply means and the device for the separating of the fuel cell system from the electrical energy source are connected.

4. A safety system in accordance with claim 3, wherein said fuel cell system comprises a fuel cell safety control and said fuel system safety control being connected to said at least one data bus.

5. A safety system in accordance with claim 3, wherein said at least one data bus is a high speed data bus.

6. A safety system in accordance with claim 2, wherein said airbag control being adapted to carry out a check of the ability to function of at least one of said sensors of said fuel cell system.

7. A safety system in accordance with claim 2, wherein said airbag control being adapted to carry out a check of the ability to function of said device3 for the switching off of said fuel supply means.

8. A safety system in accordance with claim 2, wherein said airbag control being adapted to carry out a check of the ability to function of said device for the separation of said fuel cell system from said electrical energy source.

9. A safety system in accordance with claim 2, wherein said airbag control being adapted to calibrate at least one of said sensors of said fuel cell system.

10. A safety system in accordance with claim 3 and comprising a further control, said airbag control being adapted to pass on data of said fuel cell system to said further control via said data bus.

11. A safety system in accordance with claim 2, wherein said airbag control being adapted to actuate said device for the switching off of said fuel supply means and said device for the separation of said fuel cell system from the electrical energy source as a result of the signal of at least one sensor of said airbag system.

12. A safety system in accordance with claim 2, wherein said airbag control being adapted to actuate said device for the switching off of said fuel supply means and said device for the separation of said fuel cell system from said electrical energy source using a signal which brings about the triggering of at least one of said gas generator and said belt tensioner.

13. A safety system in accordance with claim 2, wherein said energy source being connected to at least one load of at least one of said vehicle and said fuel cell system via a switch actuated electrically or electronically which is closed when power is being supplied and is opened in the absence of power being supplied.

14. A safety system in accordance with claim 2, wherein said energy source being connected to at least one load of said fuel cell system via a switch actuated electrically or electronically which is closed when power is being supplied and opened when power is not being supplied, there being in addition an electrically or electronically controlled valve associated with said fuel supply means, said valve being opened when power is being supplied and being closed when power is not being supplied.

15. A safety system in accordance with claim 2, wherein said energy source being connected to at least one load of at least one of said vehicle and said fuel cell system via a switch actuated electrically or electronically which is closed when power is being supplied and is open when power is not being supplied; there being a switching means for interrupting the power supply to said electrically or electronically actuated switch and to said electrically or electronically controlled valve, said switching means being capable of being actuated via a control signal of said airbag control.

16. A safety system in accordance with claim 2, further comprising at least one gas detector for said fuel cell system.

17. A safety system in accordance with claim 2, further comprising at least one temperature sensor for said fuel cell system.

18. A safety system in accordance with claim 2, further comprising at least one pressure sensor for said fuel cell system.

19. A safety system in accordance with claim 2, further comprising at least one current sensor for said fuel cell system.

20. A safety system in accordance with claim 1, further comprising at least one coolant resistance sensor for said fuel cell system.

21. A safety system in accordance with claim 2, wherein each said sensor being adapted to deliver one of an analogue signal and a binary signal.

22. A safety system in accordance with claim 21 and further comprising a data bus and an analogue/digital converter associated with any said sensor which delivers an analogue signal.

23. A safety system in accordance with claim 2, wherein at least one of said safety control of said fuel cell system and said airbag control including a safety logic.

24. A safety system in accordance with claim 2, wherein at least one of said safety control of said fuel cell system and said airbag control including a microprocessor.

25. A safety system in accordance with claim 24, wherein said microprocessor having an input side and an output side, there being a multiplexer associated with the microprocessor at least one of said input side and said output side.

26. A safety system for use in a vehicle comprising a powerplant driven with a gaseous fuel, a fuel supply means for said gaseous fuel, an electrical energy source, said powerplant having at least one component connectable to said electrical energy source, a plurality of sensors associated with said power plant and adapted to deliver safety relevant signals, a safety control for said powerplant, said sensors being connected to said safety control, at least one device for the switching off said fuel supply means and also preferably at least one device which can be actuated by said safety control for the separation of said at least one component from said electrical energy source, there being furthermore an airbag system having at least one airbag, at least one gas generator associated with said airbag for the inflation thereof, an airbag control controlling said gas generator, a plurality of sensors, a circuit connecting said sensors to said airbag control and adapted to deliver safety relevant signals for the triggering of said airbag, said safety control of said powerplant being one of connected to said airbag control and functionally replaced by said airbag control.

27. A safety system for use in a vehicle comprising a powerplant driven with a gaseous fuel, a fuel supply means, an electrical energy source, said powerplant having at least one component connectable to said electrical energy source, a plurality of sensors associated with said power plant and adapted to deliver safety relevant signals, a safety control for said powerplant, said sensors being connected to said safety control, at least one device for the switching off said fuel supply means and also preferably at least one device which can be actuated by said safety control for the separation of said at least one component from said electrical energy source, an airbag system having at least one airbag, at least one gas generator associated with said airbag for the inflation thereof, at least one safety belt with a belt tensioner, an airbag control controlling at least one of said gas generator and said belt tensioner, a plurality of sensors, a circuit connecting said sensors to said airbag control and adapted to deliver safety relevant signals for the triggering of the airbag and said belt tensioner, said safety control of said powerplant being one of connected to said airbag control and functionally replaced by said airbag control.
